(19) United States
(12) Patent Application Publication
(10) Pub. No.: US 2020/0379781 A1
(43) Pub. Date: Dec. 3, 2020

(54) METHODS AND SYSTEMS FOR PLUGIN DEVELOPMENT IN A NETWORKED COMPUTING ENVIRONMENT

(71) Applicant: NETAPP, INC., Sunnyvale, CA (US)

(72) Inventors: Amarnath Rachapudi, Bangalore (IN); Bharathwaj Govindharajan, Bangalore (IN); Shivakumar Venkatappa, Bangalore (IN); Dennis Christopher Fernandez, Brampton (CA)

(73) Assignee: NETAPP, INC., Sunnyvale, CA (US)

(21) Appl. No.: 16/424,049

(22) Filed: May 28, 2019

(51) Int. Cl. G06F 9/445; G06F 8/30; G06F 8/60; G06F 11/36

(52) U.S. Cl. CPC G06F 9/44526; G06F 8/30; G06F 9/44589; G06F 11/3688; G06F 8/60

(57) ABSTRACT

Methods and systems for networked computing systems is provided. One method includes generating by a processor, an application programming interface (API) template in a user preferred programming language to develop a plugin for a target system, the plugin customized for an application executed at the target system for providing a storage service associated with a storage object stored for the application; validating by the processor, an operation that the plugin has to perform for the storage service; uploading the plugin by the processor for deployment at the target system; and testing the deployed plugin by the processor at the target system. The plugin generation, validation, deployment and testing is executed using an integrated management system that provides the storage service.

### TECHNICAL FIELD

The present disclosure relates to computing systems and more particularly to, computing technology for developing, deploying and testing plugins used by computing devices in a networked environment.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple users with access to shared data, backing up data and others.

A storage system typically includes at least one computing system executing a storage operating system for storing and retrieving data on behalf of one or more client computing systems (“clients”). The storage operating system stores and manages shared data containers in a set of mass storage devices.

Storage systems are being used extensively by different applications, for example, electronic mail (email) servers, database applications, virtual machines executed within virtual machine environments (for example, a hypervisor operating environment) and others to store data, protect the data using backups.

In conventional systems, a management system is used for providing storage services, e.g. for backing up stored objects, cloning objects, restoring data containers and for other operations. Client systems typically use custom plugins for providing storage services. Typically, a plugin is developed, separately from the management system and then deployed at a server interfacing with the management system. This approach is inefficient because different users have to separately develop plugins and then deploy them for using the management system. Continuous effort is being made to develop computing technology to provide a unified platform for efficiently developing, deploying and testing plugins.

### BRIEF DESCRIPTION OF THE DRAWINGS

The foregoing features and other features will now be described with reference to the drawings of the various aspects of the present disclosure. In the drawings, the same components have the same reference numerals. The illustrated aspects are intended to illustrate, but not to limit the present disclosure. The drawings include the following Figures:

FIG. 1A shows an example of an operating environment for the various aspects disclosed herein;

FIG. 1B shows an example of a host system executing a plurality of plugins, according to one aspect of the present disclosure;

FIG. 1C shows an example of a plugin development and test module, according to one aspect of the present disclosure;

FIG. 1D shows a process for developing a plugin, according to one aspect of the present disclosure;

FIG. 1E shows a process for deploying a plugin, according to one aspect of the present disclosure;

FIG. 1F shows a process for testing a plugin at a target system, according to one aspect of the present disclosure;

FIG. 1G shows an example of a management system, according to one aspect of the present disclosure;

FIG. 2A shows an example of a cluster based storage system, used according to one aspect of the present disclosure;

FIG. 2B shows an example of a storage system node, used according to one aspect of the present disclosure;

FIG. 3 shows an example of a storage operating system, used according to one aspect of the present disclosure; and

FIG. 4 shows an example of a processing system, used according to one aspect of the present disclosure.

### DETAILED DESCRIPTION

As preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a processor, a hardware based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

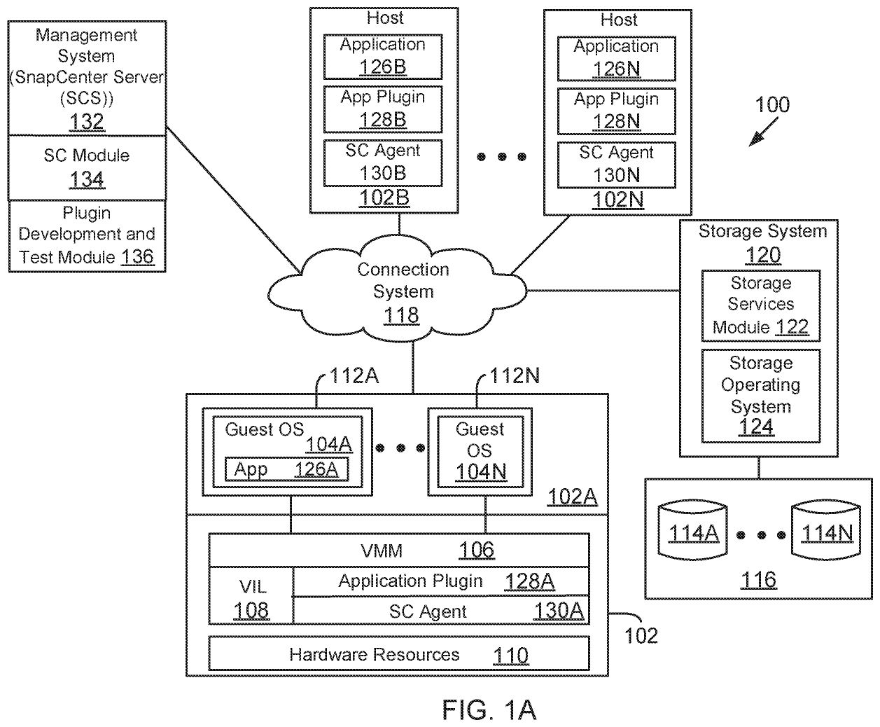

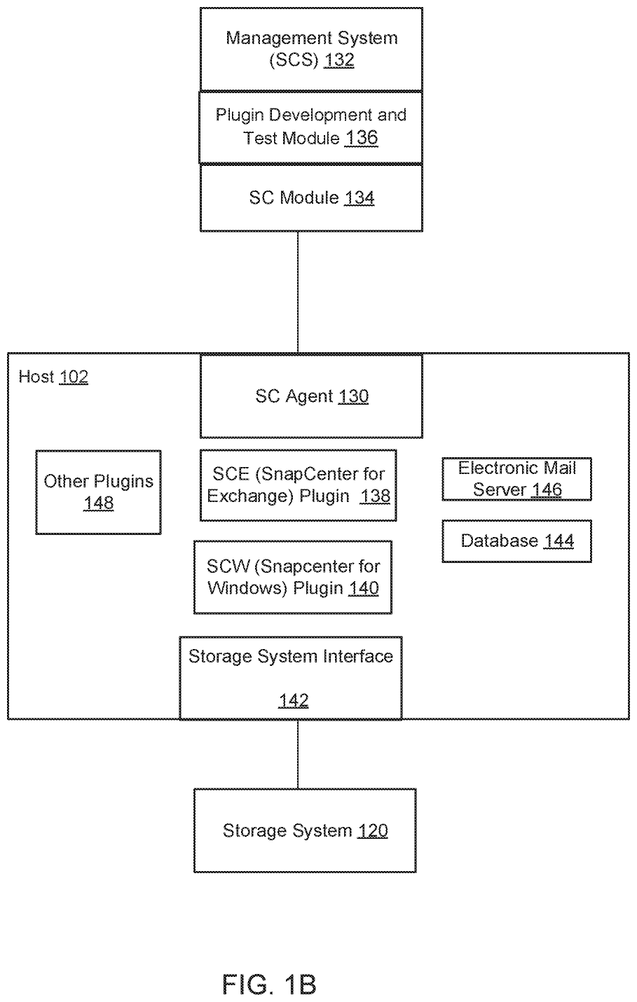

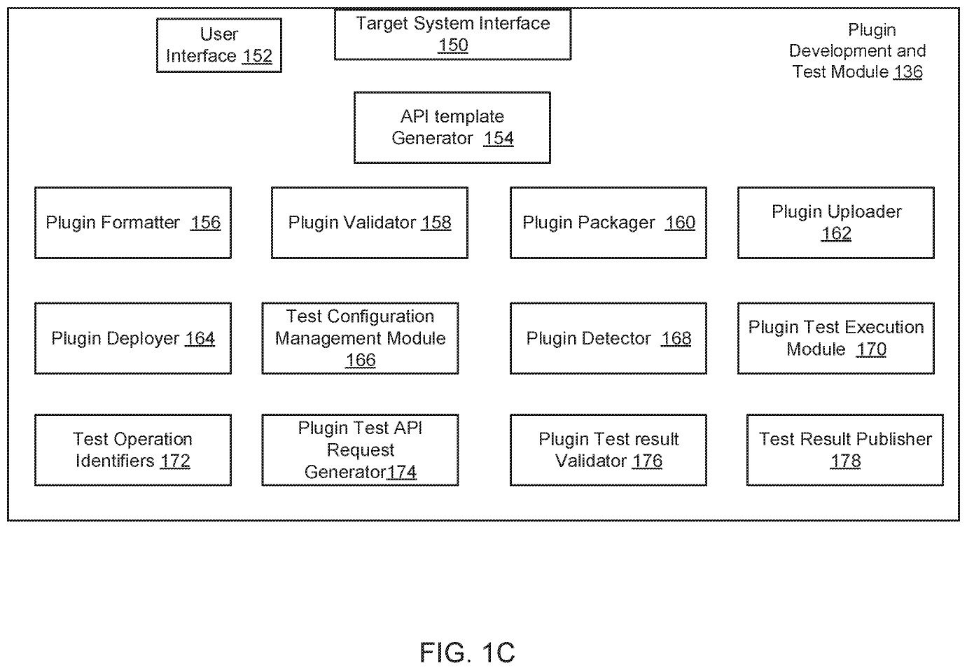

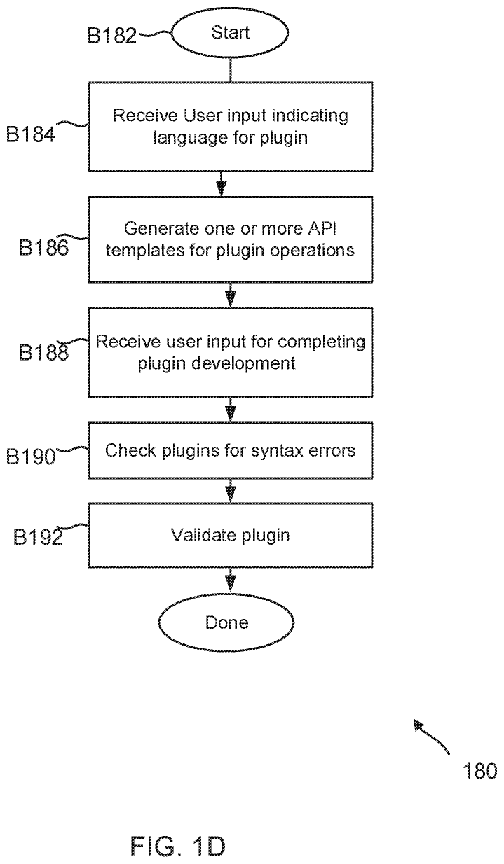

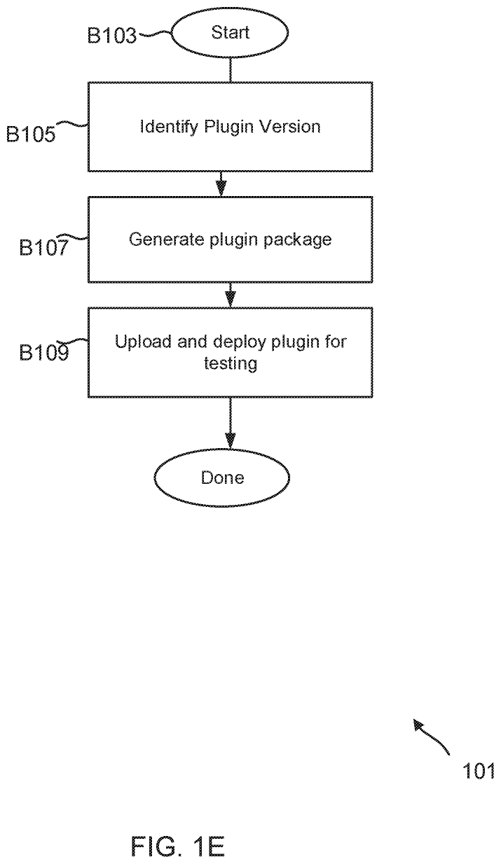

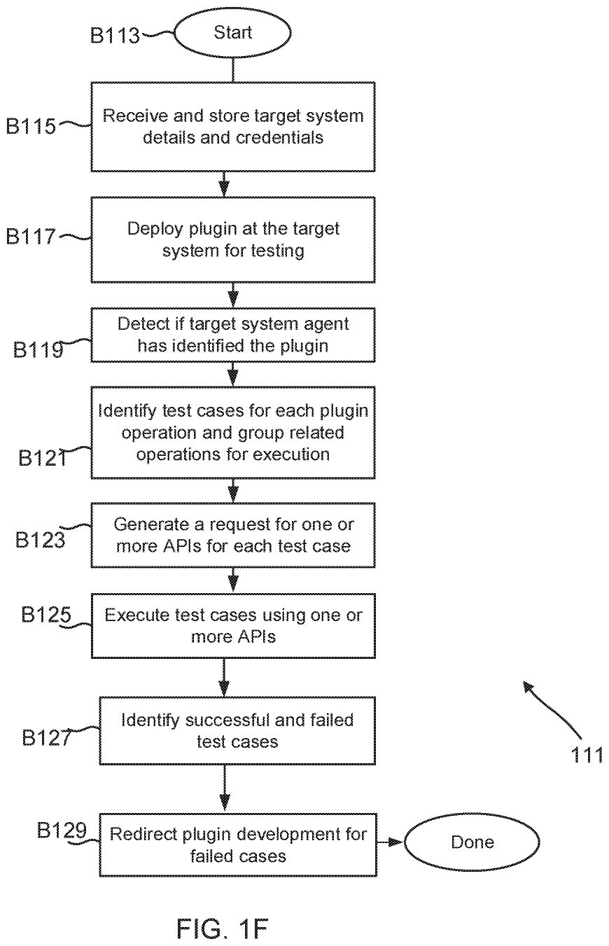

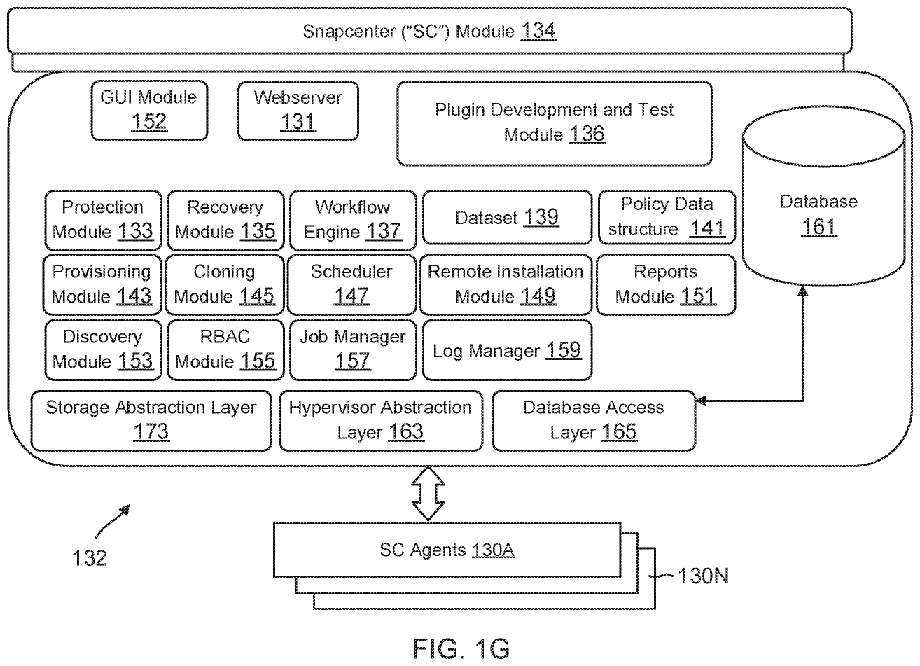

For a networked storage environment with a Server-Plugin architecture, a server component (for example, a management system 132, FIG. 1A) typically drives user actions and plugins (for example, 128A-128N, FIG. 1A) to handle operations at a target system (for example, a host system 102A-102N, FIG. 1A). For data protection software, the management system manages data protection services related operations like backup, restore, clone and other operations. The plugins that have special knowledge to interact with applications (for example, 126A-126N, FIG. 1A) including database applications (e.g. Oracle, SQL, MongoDB, HANA and others, without derogation of any third party trademark rights) perform the actual operations on application objects, e.g. stored database objects.

The term “plugin” as used in this application means a hardware processor executable software layer/code that is customized to interface with one or more applications for executing certain operations.

Conventional host systems use different applications with different databases to store application data. It is laborious for any data protection software provider to develop different database plugins for different database types used by different host systems. The same challenge is applicable for provisioning or any other management software.

A pluggable framework, for example, the management system 132 described below provides capabilities for users to develop plugins for target applications (e.g. database applications, Docker containers and others). Developing plugins involves understanding application programming interface (API) attributes (e.g. API names, API structures and others) and API operations that a plugin has to expose/provide. In conventional systems, users typically execute a protracted, tedious, error-prone and complex process to develop, test and deploy a plugin for a specific application, which is undesirable.

In one aspect, computing technology disclosed herein simplifies overall plugin development vis-à-vis conventional systems. An Integrated Development Environment (IDE) is provided to develop plugin directly from a management system. The computing technology provides a single user interface to develop, test, deploy and manage plugins in a user preferred programming language (e.g. Perl, Python, Ruby or any other language). The technology described below in detail enables users to efficiently develop plugins of their choice. The user interface enables default plugin template generation, for different programming languages, and for different plugin types, including data protection plugins for storage services.

In one aspect, the IDE environment of the present disclosure is used to generate plugin templates for a plurality of APIs/functions, including a “DiscoverResource” API to discover resources, a Quiesce API to quiesce a plugin/application, an UnQuiesce API to unquiesce a plugin/application, a Restore API to restore an object, a PreRestore API to perform pre-restore operations, a PostRestore API to perform post restore functions, a Clone API to clone an object or any other API/function. The API template code includes API definitions with a default request and response format. The API template code may also include logging modules so that users can focus on target application (e.g. database, filesystem, Docker container and other applications) operations.

In one aspect, the technology of the present disclosure enables a user to edit and save a user developed plugin and convert the plugin to a software supported plugin package e.g. a zip/tarfile with source and metadata files.

In one aspect, a user developed plugin package is deployed at a target system. A management system software then automatically discovers the plugin and enables storage service operations, e.g. backup/recovery/clone of storage objects. The IDE provides an option to test the various plugin operations and then qualify the plugin for the target system. Performing an operation e.g. backup involves certain pre-backup operations, including resource discovery, resource configuration and other operations. The IDE and the management system handle the pre-backup operations for executing a test operation.

In one aspect, the disclosed technology provides a user interface from a management system to simplify plugin development, testing, and deployment. This enables user systems to correct programming and logical errors, during development, deployment, and post deployment.

System 100:

FIG. 1A shows an example of a system 100, where the various adaptive aspects disclosed herein may be implemented. System 100 includes a plugin development and test module 136 (may be referred to as module 136) accessible from the management system 132 for developing, deploying and testing plugins, as described below in detail. It is noteworthy that although the description of module 136 is provided in the context of system 100 components, the adaptive aspects of the present disclosure may be implemented in any computing environment that uses plugins associated with one or more applications.

In one aspect, system 100 includes at least a host computing system 102 (shown as host systems 102A-102N and may also be referred to as server 102 or target system 102) communicably coupled to a storage system 120 executing a storage operating system 124 via a connection system 118 such as a local area network (LAN), wide area network (WAN), the Internet and others. As described herein, the term “communicably coupled” may refer to a direct connection, a network connection, or other connections to enable communication between computing and network devices.

System 100 includes the management system (may also be referred to as “Snapcenter Server” or “SCS” (without derogation of any trademark rights of NetApp Inc., the assignee of the present application) 132 that executes instructions for a management module (or application) (may be referred to as SnapCenter module (“SC module” or “SCM”) 134 for coordinating storage services related operations (for example, backups, restore, cloning and other operations) for different applications and plugins. Although SCS 132 is shown as a stand-alone module, it may be implemented with other applications, for example, within a virtual machine environment, as described below.

It is also noteworthy that SCS 132 is referred to herein as a SnapCenter server only as an example, and may be referred to or described using different terminology (for example, a central snap server, a central storage services provider, snap manager server and other descriptive terms). The various aspects described herein are of course not limited by how SCS 132 is categorized or the terminology used to describe its innovative functionality, described below in more detail. Furthermore, SCS 132 and the SC module 134 may be referred to interchangeably throughout this specification.

The management system 132 provides access to module 136 that can be used by a user to develop custom plugins, as described below in detail.

In one aspect, host systems 102 may execute a plurality of applications 126A-126N, for example, an email server (Exchange server), a database application (for example, SQL database application, Oracle database application and others) and others. These applications may be executed in different operating environments, for example, a virtual machine environment (described below), Windows, Solaris, Unix and others. The applications may use storage system 120 to store information at storage devices 114 in a storage sub-system 116.

To protect information associated with each application, a plugin (shown as application plugins 128A-128N) are used. The term protect means to backup an application and/or backup associated information (including configuration information, data (files, directories, structured or unstructured data) and others (may jointly be referred to as data containers)). It is noteworthy that the adaptive aspects described herein are not limited to plugins for protecting information.

Each host system also executes an agent 130A-130N (may be referred to as SMcore or SC agent 130) that interfaces with the management system 132 and the various application plugins for managing backups, restore, cloning and other operations, as described below in detail.

In one aspect, the storage system 120 has access to a set of mass storage devices 114A-114N (may be referred to as storage devices 114) within at least one storage subsystem 116. The storage devices 114 may include writable storage device media such as magnetic disks, video tape, optical, DVD, magnetic tape, non-volatile memory devices for example, self-encrypting drives, flash memory devices and any other similar media adapted to store structured or non-structured data. The storage devices 114 may be organized as one or more groups of Redundant Array of Independent (or Inexpensive) Disks (RAID). The various aspects disclosed are not limited to any particular storage device or storage device configuration.

The storage system 120 provides a set of storage volumes to the host systems 102 via connection system 118. The storage operating system 124 can present or export data stored at storage devices 114 as a volume (or logical unit number (LUN)). Each volume may be configured to store data files (or data containers or data objects), scripts, word processing documents, executable programs, and any other type of structured or unstructured data. From the perspective of one of the client systems, each volume can appear to be a single storage drive. However, each volume can represent the storage space in one storage device, an aggregate of some or all of the storage space in multiple storage devices, a RAID group, or any other suitable set of storage space. An aggregate is typically managed by a storage operating system 124 and identified by a unique identifier (not shown). It is noteworthy that the term “disk” as used herein is intended to mean any persistent storage device/space and not to limit the adaptive aspects to any particular type of storage device, for example, hard disks.

The storage system 120 may be used to store and manage information at storage devices 114 based on a request generated by an application executed by a host system or any other entity. The request may be based on file-based access protocols, for example, the Common Internet File System (CIFS) protocol or Network File System (NFS) protocol, over the Transmission Control Protocol/Internet Protocol (TCP/IP). Alternatively, the request may use block-based access protocols, for example, the Small Computer Systems Interface (SCSI) protocol encapsulated over TCP (iSCSI) and SCSI encapsulated over Fibre Channel (FC).

In a typical mode of operation, one or more input/output (I/O) commands, such as an NFS or CIFS request, is sent over connection system 118 to the storage system 120. Storage system 120 receives the request, issues one or more I/O commands to storage devices 114 to read or write the data on behalf of the client system, and issues an NFS or CIFS response containing the requested data over the network 118 to the respective client system.

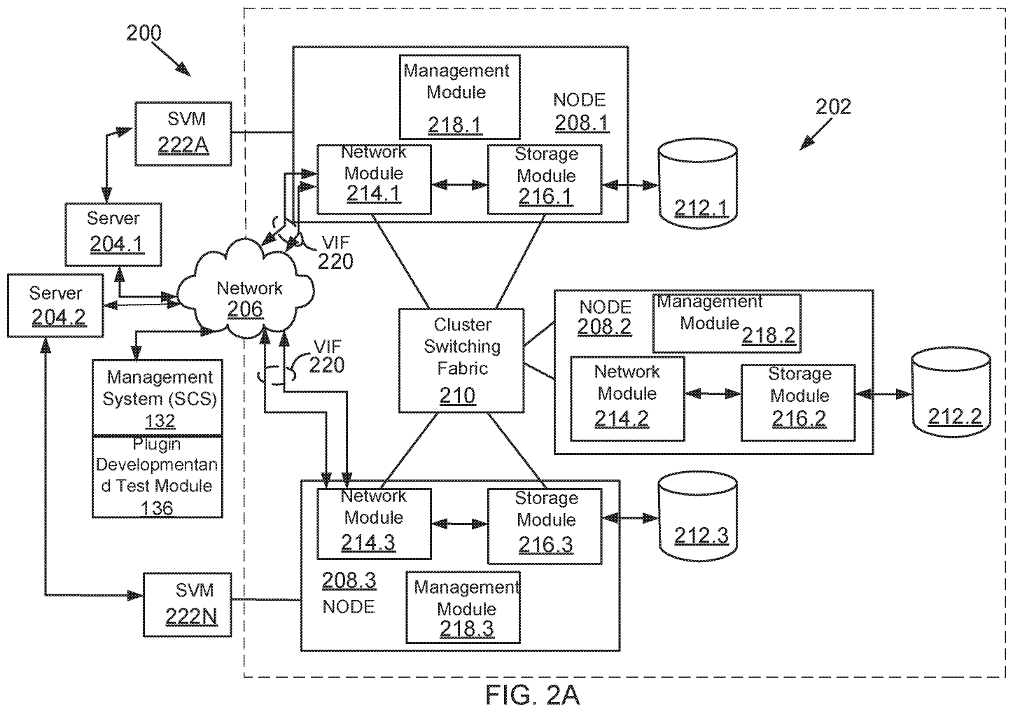

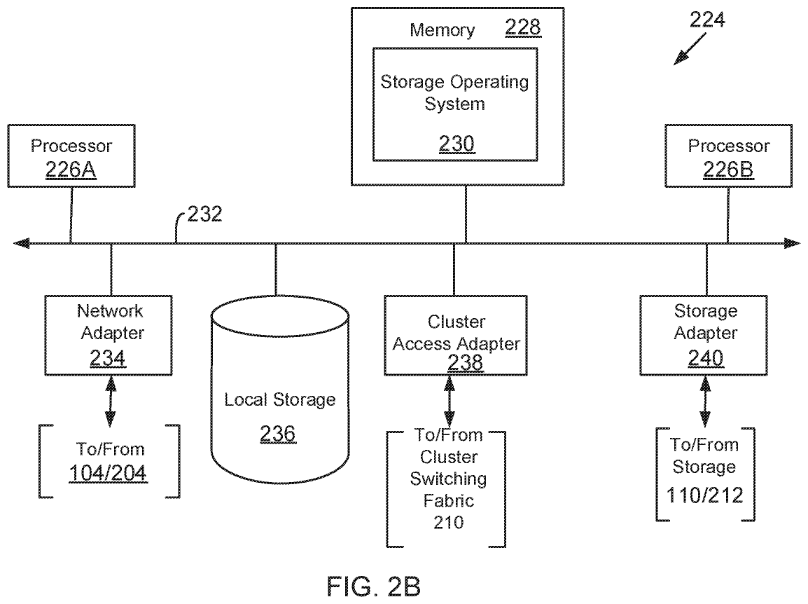

Although storage system 120 is shown as a stand-alone system, i.e. a non-cluster based system, in another aspect, storage system 120 may have a distributed architecture; for example, a cluster based system that may include a separate network module and storage module. Briefly, the network module is used to communicate with host systems 102, while the storage module is used to communicate with the storage devices 114, as described below with respect to FIG. 2A.

Alternatively, storage system 120 may have an integrated architecture, where the network and data components are included within a single chassis. The storage system 120 further may be coupled through a switching fabric to other similar storage systems (not shown) which have their own local storage subsystems. In this way, all of the storage subsystems can form a single storage pool, to which any client of any of the storage servers has access.

Storage system 120 also executes or includes a storage services module 122 that coordinates storage volume backups, cloning, restore and replication for different hosts and different applications. Although storage services module 122 is shown as a single block, it may include various modules to taking backups, cloning restore operations, replicating backups from one location to another and so forth. As described below, backups and other operations may be performed using the management system 132 and SC module 134. As an example, taking backups may include taking snapshots, i.e. a point-in-time copy of a storage volume. The point-in-time copy captures all the information in a storage volume. The snapshot may be used to restore a storage volume at any given time.

Storage system 120 also protects snapshots by replicating snapshots stored at a first storage system (may be referred to as primary storage) and replicating it to a secondary storage source. Different technologies, including the SnapVault and SnapMirror technologies of NetApp Inc. (without derogation of any trademark rights of NetApp Inc.) may be used to protect storage volumes.

SnapVault is primarily intended for disk-to-disk backups. SnapVault leverages NetApp Snapshot technology to back up and restore systems at a block level. SnapVault identifies and copies only the changed blocks of a system to secondary storage. SnapMirror takes a mirror copy of a storage volume and stores it at a remote location/disaster recovery site. SnapMirror can occur either at volume level or at Qtree level. The various techniques described herein are not limited to any specific replication; protection technology.

One or more of the host systems (for example, 102A) may execute a virtual machine environment where a physical resource is time-shared among a plurality of independently operating processor executable virtual machines (also referred to as VMs). Each VM may function as a self-contained platform, running its own operating system (OS) and computer executable, application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (may also be referred to as a host system) which may be referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host system.

Host system 102A provides a processor executable virtual machine environment executing a plurality of VMs 112A-112N. VMs 112A-112N execute a plurality of guest OS 104A-104N (may also be referred to as guest OS 104) to share hardware resources 110. As described above, hardware resources 110 may include CPU, memory, I/O devices, storage or any other hardware resource.

In one aspect, host system 102A may also include a virtual machine monitor (VMM) 106, for example, a processor executed hypervisor layer provided by VMWare Inc., Hyper-V layer provided by Microsoft Corporation of Redmond, Wash. or any other layer type. VMM 106 presents and manages the plurality of guest OS 104A-104N executed by the host system 102A.

In one aspect, VMM 106 is executed by host system 102A with VMs 112A-112N. In another aspect, VMM 106 may be executed by an independent stand-alone computing system, often referred to as a hypervisor server or VMM server and VMs 112A-112N are presented on another computing system.

It is noteworthy that various vendors provide virtualization environments, for example, VMware Corporation, Microsoft Corporation and others (without derogation of any third party trademark rights). The generic virtualization environment described above with respect to FIG. 1A may be customized depending on the virtual environment provider.

VMM 106 may include or interface with a virtualization layer (VIL) 108 that provides one or more virtualized hardware resource 110 to each OS 104A-104N. VMM 106 also includes or interfaces with a hypervisor plugin (shown as application plugin 128A) and the SC agent 130A.

FIG. 1B shows an example of a portion of the system 100, described above with respect to FIG. 1A. As an example, host 102 executes an electronic mail server application 146 and the data for application 146 is stored in a database 144. As an example, application 146 may be a Microsoft Exchange server [without derogation of any trademark rights). It is noteworthy that although the example of FIG. 1B is based on Exchange, the adaptive aspects are not limited to Exchange or any other application type.

In one aspect, SC agent 130 interfaces with the SC module 134 via a network connection. The SC agent 130 receives requests for backup and provides the request to a SC Exchange (SCE) plugin 138 that may be developed by module 136, as described below. The SCE plugin 138 is customized for application 146 and interfaces with application 146 to perform electronic mail related specific portions of discovery, backup and restore operations. It is noteworthy that the host 102 may also execute other plugins 148, besides plugins 138 and 140.

As an example, host 102 also executes a Windows based operating system (without derogation to any trademark rights). A plugin, SCW (Snapcenter for Windows) 140 is provided for exposing APIs for a backup service. To backup database 144, the storage system 120 creates a snapshot of the data. The storage system 120 is accessed using a storage system interface 142.

Plugin Development and Test Module 136:

FIG. 1C shows a block diagram of module 36 that provides an IDE to a user for developing plugins, according to one aspect of the present disclosure. It is noteworthy that although the various components of module 136 are shown within a single block, the functionality of the various blocks may be distributed and implemented across different computing devices, for example some of the components may be implemented within the management system 132 and the target (or host) system 102. In one aspect, module 136 is provided as a selectable option from the SC module 134.

In one aspect, module 136 interfaces with the target system 102 via a target system interface 150. The target system interface 150 includes logic to send and receive information from the target system 102.

Module 136 includes a user interface 152 to receive user input. The user interface 152 may be presented by the SC module 134. The user input may be received via a graphical user interface, a command line interface or by any other structure to develop a plugin for an application. The user input defines a preferred language for the plugin and includes information regarding request/response format for the plugin. In one aspect, user interface 152 provides a single, consolidated interface for developing, deploying and testing a plugin.

In one aspect, module 136 includes an API template generator 154 that receives a language preference from a user input. The language preference defines a programming language (e.g. Perl, Python, Ruby or any other language) for the plugin that the user wants to develop. This input may be received via the user interface 152. The API template generator 154 generates API templates for a user request. The API template generator 154 communicates with the SC module 134 to determine what APIs are needed for the plugin that the user wants to develop. Based on the information from the SC module 134, the API templates are generated in the preferred language.

A plugin formatter 156 checks the API template code for syntax errors. A plugin validator 158 validates the various operations that the plugin needs to execute. The plugin is then saved at a storage device. In one aspect, the storage device is managed by the target system 102.

To deploy the plugin, a version manager (not shown) identifies a plugin version. A plugin packager 160 creates a plugin package and a plugin uploader 162 uploads the plugin to the target system 102. A plugin deployer 164 then deploys the plugin at the target system 102.

To test the plugin, the user provides target system details and credentials to a test configuration module 166. The plugin deployer 164 first deploys the plugin within the target system 102. A plugin detector 168 detects if the SC agent 130 at the target system 102 identifies the plugin. If there are any issues with identifying the plugin, then the plugin detector 168 generates an error.

In one aspect, test operation identifiers 172 are used to identify any test cases for each plugin operation (e.g. a test case to quiesce or unquiesce the plugin). In one aspect, related operations are grouped together for testing.

A plugin test API request generator 174 creates requests for each API that is needed for the test cases. The plugin test execution module 170 executes the various tests. The test results are captured and provided to a plugin test result validator 176.

The plugin test result validator 176 identifies whether the test cases were successful or unsuccessful using the test identifiers 172. The test results are published by the test result publisher 178. For any failed tests, the code for the plugin is modified or updated. Details regarding using the various components of module 136 are provided below.

Plugin Development:

FIG. 1D shows a process 180 for developing a plugin using module 136 in an IDE, according to one aspect of the present disclosure. Process 180 begins in block B182, when a user has decided to develop a plugin for an application at a target system 102. In one aspect, the plugin may be for the target system 102 for a storage service that is managed by the SC module 134, described above. In one aspect, the plugin may be expected to perform certain operations, e.g. discovery operations to discover files, quiescing an application and unquiescing an application for a backup operation, assisting in pre-restore and post restore operations for restoring a stored application object, or any other operation. Different APIs may be needed for different operations. The plugin may involve one or more operations at the target system 102, storage system 120 or any other component. It is noteworthy that process 180 is not limited to any particular type of plugin or operation type.

In block B184, the user defines a language for the plugin. For example, the user may specify or select a language preference (Perl, Python or any other language) via the user interface 152 presented by the management system 132.

In block B186, the API template generator 154 generates API templates for one or more operations of the plugin. In one aspect, the API template generator 154 interfaces with the SC module 134 to obtain information regarding the API templates. The SC module 134 provides information to the API template generator 154 as to the different APIs that may be used/needed by the plugin.

In response to the API templates, in block B188, user input is received for completing the initial plugin development. The user input may include business logic, preference for request/response formats for the plugin or any other information. The user input will vary based on the intended plugin functionality and is not limited to any specific functionality.

In block B190, the plugin formatter 156 formats the plugin and checks for any syntax errors. In block B192, the plugin validator 158 validates the plugin. In one aspect, the plugin validator 158 is a semantic validator that performs functional checks for the plugin code base. Thereafter, the plugin is ready for deployment described below with respect to FIG. 1E, and testing described below with respect to FIG. 1F.

Plugin Deployment:

FIG. 1E shows a process 101 for deploying a plugin, according to one aspect of the present disclosure. Process 101 begins in block B103 after a plugin has been developed using the process blocks of FIG. 1D and module 136, described above in detail. In block B105, a version manager (not shown) identifies a plugin version. The plugin packager 160 generates a plugin package in block B107. In block B109, the plugin package is uploaded and deployed by plugin deployer 164 at the target system 102. The plugin is also saved at a repository for future access. Thereafter, the plugin is ready for testing, as described below.

Plugin Testing:

FIG. 1F shows a process 111 for testing a plugin at the target system 102 or any other computing device, according to one aspect of the present disclosure. Process 111 begins in block B113 after a plugin has been developed and deployed, as described above with respect to FIGS. 1D and 1E, respectively.

In block B115, the test configuration management module 166 receives and stores target system details and credentials. The details include target system operating environment, identfiers, if any, target system resource information, or any other relevant information.

In block B117, the plugin is deployed for testing by the plugin deployer 164. In block B119, the plugin detector 168 detects if an agent at the target system 102 (e.g. SC agent 130) has identified the plugin. If the agent failed to identify the plugin, then an error may be generated by the plugin detector 168.

If the plugin has been identified, then in block B121, the test cases that are applicable to each test operation are identified, e.g. discovery, quiesce, unquiesce, pre-restore, restore or any other operations. The test operations are identified using unique identifiers 172. To improve test performance, related test operations are grouped for execution.

In block B123, one or more requests are generated by the plugin test API request generator 174 for each test case. In block B125, the plugin test execution module 170 executes the test cases using one or more APIs. Certain test cases may be executed in parallel, while others may be executed sequentially. The plugin test execution module 170 captures the test results and provides them to the plugin test result validator 176.

In block B127, the plugin test result validator 176 identifies the successful and failed test cases using the test identfiers 172. The test results are published in block B129 by the test result publisher 178. With respect to failed test results, the process reverts back to FIG. 1D, where the plugin development is modified/updated to avoid test failures.

SCS 132:

FIG. 1G shows a block-level diagram of SCS 132 having the SC module 134 with module 136, according to one aspect of the present disclosure. In this example, module 136 may be used and accessed via SC module 134 to execute the various process blocks described above.

As an example, the SC module 134 may be executed by a stand-alone system or may interface or is integrated with another management console/application to manage and interface with multiple instances of SC agents' 130A-130N. SC module 134 may also be implemented as an application within a VM environment.

The SC module 134 includes a graphical user interface (GUI) module 152 that presents a GUI at a display device, for example, a monitor, a smart phone, tablet or any other display device type. The GUIs may be used by different users to interface with SCS 132 and its components, for example to interface with module 136 to develop a plugin as described. It is noteworthy that the various aspects described herein are not limited to any specific GUI type because a command line interface (CLI) may also be used to implement the adaptive aspects described herein.

The SC module 134 may also include a web server 131 for enabling Internet based communication. As an example, web server 131 may be implemented as an Internet Information Services (IIS) for a Windows® Server web server (without derogation of any third party trademark rights). The web server 131 interfaces with a workflow engine 137 that coordinates and manages various tasks that are performed by the different components of the SC module 134.

In one aspect, the workflow engine 137 coordinates dataset 139 creation, policy allocation and manage a database 161. The workflow engine 137 also communicates with various SC agents 130A-130N for host system related operations including backup, cloning, restore and other operations.

In one aspect, the SC module 134 also includes a protection module 133, a provisioning module 143, a discovery module 153, a recovery module 135, a cloning module 145, a role based access control (RBAC) module 155, a storage abstraction layer (may also be referred to as “SAL”) 173, a hypervisor abstraction layer (may also be referred to as “HAL”) 163, a scheduler 147, a job manager 157, a remote installation module 149, a log manager 159, a policy data structure 141, a reports module 151 and a database access layer 165 that can access the database (or any other data structure type) 161. The database 161 stores various data structures (or objects) in a format that allows SC module 134 to handle storage services for different applications/host systems.

The log manager 159 collects logs from SC agents and the various plugins. The logs can then be presented to a user via a GUI. The logs may be for event management and audit for various SCS 132 operations. The logs may be collected for a job based on a job identifier.

The protection module 133 is used to enforce a policy for a particular storage services related job. The protection module 133 maintains a protection policy for a plurality of objects (or protection group) that are to be backed up and provides protection service for backing up the protection group objects. Based on an application object, a call is made to an appropriate plugin for providing the appropriate protection service. The appropriate plugin is developed by module 136, as described above.

In one aspect, protection module 133 maintains protection group objects for abstract representation of a container of application objects where protection of application objects is defined by policy objects. The protection group objects map to dataset objects 139.

The provisioning module 143 allows a user to configure and provision a LUN/volume (used interchangeably) that may be used to store information. The provisioning module 143 allows a user to set a LUN size and appropriate permissions for using the LUN, for example, reading and writing data, permission for changing a LUN size, deleting a LUN and other operations. Storage volume information is saved in a standard format at database 161 and includes, name of the storage volume, storage connection identifier (described below), size, a junction path, date volume was created and an aggregate.

The discovery module 153 interfaces with the SC agents 130A-130N executed at different host systems to obtain information regarding the host systems, storage resources used by various applications and information regarding data containers that are protected (i.e. backed up) and unprotected. The discovery module 153 also facilitates discovery and management of application specific objects, for example, VMs, databases, hypervisor and others. Based on the application type, an appropriate plugin is used to discover different objects.

In one aspect, the discovery module 153 initiates a discovery operation with the SC agents. An API presented by the SCS 132 determines if a SC agent is installed at a host. If the SC agent is installed, then the SC agent discovers the various plugins at that host. If the SC agent is not installed, then it is installed by the remote installation module 149 and the appropriate plugins are installed as well.

The cloning module 145 is used to clone storage volumes that are maintained by the storage system 120. The cloning module 145 is also used for managing the life cycle of a clone. The term clone as used herein is a duplicate copy of a snapshot. The term clone life cycle management means generating a clone, refreshing a clone and deleting a clone based on user defined policies and requirements. Refreshing a clone means deleting an existing clone, generating a new snapshot and then creating the clone again.

The RBAC module 155 stores information regarding different clients/entities that are given access to storage. For example, a particular business unit may be allowed to read certain storage volumes and may not be allowed to backup, clone, replicate or delete any storage volumes. The RBAC module 155 manages the various roles and access type for different applications that may be executed in different host systems/computing environments.

In one aspect, RBAC module 155 includes an authentication and authorization module. User authentication may happen at multiple end points, for example, via a GUI login, a login API for clients or plugins and others. The authentication module authenticates users against different domain/subsystem requirements, for example, an Active Directory, a local Windows machine host system, open LDAP (lightweight directory protocol) and others. Once a user is authenticated, an encrypted token is generated based on user information. In another aspect, a hash token is generated based on the generated token. The hashed token is saved at database 161. The hashed token may be based on MD5 (Message Digest Algorithm, 5, SHA (secure hash algorithm)-1 or any other technique.

When the authenticated user logs back in, the user passes the token and the SCS 132 decrypts the token, validates the token and regenerates the hash value. The hash value is compared with the stored hash value in database 161.

In one aspect, the authorization module of the RBAC module 155 creates custom roles (for example, a SCS administrator, backup administrator, backup operator, backup viewer, restore administrator and others), modifies existing roles, assigns and unassigns permissions to and from a role (for example, a dataset, policy, host, storage connection, a dashboard, a report, discovery, remote installation and others), assigns and unassigns users to roles and assigns and unassigns resources (for example, hosts, datasets, policy and others).

In one aspect, roles determine a set of capabilities that are available to members of the role. For example, a backup administrator may be allowed to add a host system, install plugins, create a dataset, create a backup dataset, delete a dataset, create policies, delete backups, restore applications and others. A backup operator may be allowed to start and stop existing dataset jobs, monitor backups, view backup reports and perform application level restore operations. A backup viewer may be given read only access to backups, view existing backups and review job session details. A restore administrator may be allowed to perform restore operations using existing backups. The adaptive aspects described herein are not limited to these roles.

All the tasks conducted by the SC module 134 are organized and monitored by the job manager 157. The job schedules are managed by the scheduler 147. When a new job arrives, the job manager 157 stores the job information in a database (for example, 161) with other existing jobs. The job manager 157 creates sub-tasks for executing the appropriate work flows. The sub-tasks depend on the nature of the job (for example, backup, restore, cloning or others). The job manager 157 updates the status of each task to provide real-time updates via a GUI.

In one aspect, the policy data structure 141 is used to store polices for different stored objects (for example, data structures, VMs, storage volumes and others). The policy information is configurable and may be changed by a user. In one aspect, the policy data structure 141 format is the same across different applications. This enables SC module 134 to manage storage services across different platforms with different requirements and operating parameters. The policy data structure 141 includes various policy objects to store various policies each with a set of attributes that can be applied to any dataset. The policy object stores a policy identifier, a policy name, description, a backup schedule policy, a retention count as to how long a backup is to be retained, a replication policy to replicate a backup from one location to another, types of backups, application consistent backups, and verification policies to verify a backup and others. It is noteworthy that a policy object may be shared across multiple datasets for multiple applications/plugins.

The reports module 151 is used to provide reports to users. The reports may be for different applications and in different formats.

In one aspect, the SC module 134 maintains the dataset 139 for different applications and application objects. Each dataset is uniquely identified and named. The dataset format for managing replication for different applications is the same, regardless of how the applications handle information. A dataset may be associated with a policy data structure that defines how an object is to be protected. The dataset format used by the various aspects of the present disclosure allows a user to add or remove stored objects that need to be protected.

In one aspect, dataset 139 represents a container of application objects where protection attributes may be defined in terms of backup policy, replication profiles and retention policies. Dataset 139 is a basic unit that is used to manage backup operations. A user can add any permissible resource to the dataset from multiple host systems/applications.

The database access layer 165 saves information in the database 161. The database 161 may be used to store information that is discovered by the discovery module 153, policy information, host information, datasets and other information.

In one aspect, the database 161 may store various data structures for managing the storage services and providing status to users. As an example, the database schema for the database 161 is application format independent and may include various data structures to identify different host systems to specific login information, a backup metadata structure for storing information regarding backups, a data structure to map backups to stored objects including VMs, databases and others, a data structure for storing information on backup types, i.e. application consistent, full backup, copy backup, log backup for identifying volumes that are involved in each backup, a data structure to track various jobs that are managed by the job manager 157, discovery objects for storing information that is discovered by the discovery module 153, policy data structure 141, storage footprint and storage resource information, a data structure for storing information regarding various plugins, roles, role attributes, storage connections and user information, including credentials.

In one aspect, SAL 173 stores information regarding the various storage resources that are used and available for different hosts. SAL 173 maintains a “storage footprint” for different storage resources (for example, storage systems including storage devices) used by different applications as described below in detail.

In one aspect, HAL 163 is used to communicate with another plugin that is used to collect information related to storage used by different virtual machines.

In one aspect, methods and systems for a networked storage environment is provided. One method includes generating by a processor, an application programming interface (API) template in a user preferred programming language to develop a plugin for a target system, the plugin customized for an application executed at the target system for providing a storage service associated with a storage object stored for the application; validating by the processor, an operation that the plugin has to perform for the storage service; uploading the plugin by the processor for deployment at the target system; and testing the deployed plugin by the processor at the target system. The plugin generation, validation, deployment and testing is executed using an integrated management system that provides the storage service.

Clustered Storage System:

FIG. 2A depicts an illustrative aspect of a shared, storage environment 200, similar to storage system 120. The shared, storage environment 200 includes module 136 that is accessible via the management system 132 as part of the IDE for developing plugins, a plurality of server systems 204.1-204.2 (similar to server systems 102), a clustered storage system 202 and at least one computer network 206 communicably connecting the server systems 204.1-204.2 and the clustered storage system 202.

The clustered storage system 202 includes a plurality of nodes 208.1-208.3, a cluster switching fabric 210, and a plurality of mass storage devices 212.1-212.3 (similar to 110, FIG. 1A). Each of the plurality of nodes 208.1-208.3 is configured to include a network module, a storage module, and a management module, each of which can be implemented as a separate processor executable or machine implemented module. Specifically, node 208.1 includes a network module 214.1, a storage module 216.1, and a management module 218.1, node 208.2 includes a network module 214.2, a storage module 216.2, and a management module 218.2, and node 208.3 includes a network module 214.3, a storage module 216.3, and a management module 218.3.

The network modules 214.1-214.3 include functionality that enables the respective nodes 208.1-208.3 to connect to one or more of the client systems 204.1-204.2 over the computer network 206, while the storage modules 216.1-216.3 connect to one or more of the storage devices 212.1-212.3.

The management modules 218.1-218.3 provide management functions for the clustered storage system 202. Accordingly, each of the plurality of server nodes 208.1-208.3 in the clustered storage server arrangement provides the functionality of a storage server.

A switched virtualization layer including a plurality of virtual interfaces (VIFs) 220 is provided below the interface between the respective network modules 214.1-214.3 and the client systems 204.1-204.2, allowing storage 212.1-212.3 associated with the nodes 208.1-208.3 to be presented to the client systems 204.1-204.2 as a single shared storage pool. For example, the switched virtualization layer may implement a virtual interface architecture. FIG. 2A depicts only the VIFs 220 at the interfaces to the network modules 214.1, 214.3 for clarity of illustration.

The clustered storage system 202 can be organized into any suitable number of virtual servers (VServer or storage virtual machines (SVM)) 222A-222N, in which each virtual storage system represents a single storage system namespace with separate network access. Each virtual storage system has a user domain and a security domain that are separate from the user and security domains of other virtual storage systems. Server systems 204 can access storage space via a VServer from any node of the clustered system 202.

Each of the nodes 208.1-208.3 may be defined as a computer adapted to provide application services to one or more of the client systems 204.1-204.2. In this context, a SVM is an instance of an application service provided to a client system. The nodes 208.1-208.3 are interconnected by the switching fabric 210, which, for example, may be embodied as a Gigabit Ethernet switch or any other switch type.

Although FIG. 2A depicts three network modules 214.1-214.3, the storage modules 216.1-216.3, and the management modules 218.1-218.3, any other suitable number of network modules, storage modules, and management modules may be provided. There may also be different numbers of network modules, storage modules, and/or management modules within the clustered storage system 202. For example, in alternative aspects, the clustered storage system 202 may include a plurality of network modules and a plurality of storage modules interconnected in a configuration that does not reflect a one-to-one correspondence between the network modules and storage modules.

The server systems 204.1-204.2 of FIG. 2A may be implemented as computing devices configured to interact with the respective nodes 208.1-208.3 in accordance with a client/server model of information delivery. In the presently disclosed aspect, the interaction between the server systems 204.1-204.2 and the nodes 208.1-208.3 enable the provision of network data storage services. Specifically, each server system 204.1, 204.2 may request the services of one of the respective nodes 208.1, 208.2, 208.3, and that node may return the results of the services requested by the client system by exchanging packets over the computer network 206, which may be wire-based, optical fiber, wireless, or any other suitable combination thereof. The server systems 204.1-204.2 may issue packets according to file-based access protocols, such as the NFS or CIFS protocol, when accessing information in the form of files and directories.

In a typical mode of operation, one of the server systems 204.1-204.2 transmits an NFS or CIFS request for data to one of the nodes 208.1-208.3 within the clustered storage system 202, and the VIF 220 associated with the respective node receives the client request. It is noted that each VIF 220 within the clustered system 202 is a network endpoint having an associated IP address. The server request typically includes a file handle for a data file stored in a specified volume on at storage 212.1-212.3.

Storage System Node:

FIG. 2B is a block diagram of a system 224, according to one aspect. System 224 may be used by a stand-alone storage system 120 and/or a storage system node operating within a clustered storage system node for performing various storage services described above. System 224 communicates with the management system 132 and the various plugins used at servers 102 providing information regarding stored objects, backups, clones, restore operations and other operations.

System 224 may include a plurality of processors 226A and 226B, a memory 228, a network adapter 234, a cluster access adapter 238 (used for a cluster environment), a storage adapter 240 and local storage 236 interconnected by a system bus 232. The local storage 236 comprises one or more storage devices, such as disks, utilized by the processors to locally store configuration and other information.

The cluster access adapter 238 comprises a plurality of ports adapted to couple system 224 to other nodes of a cluster as described above with respect to FIG. 2A. In the illustrative aspect, Ethernet may be used as the clustering protocol and interconnect media, although it will be apparent to those skilled in the art that other types of protocols and interconnects may be utilized within the cluster architecture described herein.

System 224 is illustratively embodied as a dual processor storage system executing a storage operating system 230 (similar to 124, FIG. 1A) that preferably implements a high-level module, such as a file system, to logically organize information as a hierarchical structure of named directories, files and special types of files called virtual disks (hereinafter generally “blocks”) on storage devices 114/212. However, it will be apparent to those of ordinary skill in the art that the system 224 may alternatively comprise a single or more than two processor systems. Illustratively, one processor 226 executes the functions of a network module on a node, while the other processor 226B executes the functions of a storage module.

The memory 228 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions described herein.

The storage operating system 230, portions of which is typically resident in memory and executed by the processing elements, functionally organizes the system 224 by, inter alia, invoking storage operations in support of the storage service provided by storage system 120. An example of operating system 230 is the DATA ONTAP® (Registered trademark of NetApp, Inc. operating system available from NetApp, Inc. that implements a Write Anywhere File Layout (WAFL® (Registered trademark of NetApp, Inc.)) file system. However, it is expressly contemplated that any appropriate storage operating system may be enhanced for use in accordance with the inventive principles described herein. As such, where the term “ONTAP” is employed, it should be taken broadly to refer to any storage operating system that is otherwise adaptable to the teachings of this invention.

The network adapter 234 comprises a plurality of ports adapted to couple the system 224 to one or more server systems over point-to-point links, wide area networks, virtual private networks implemented over a public network (Internet) or a shared local area network. The network adapter 234 thus may comprise the mechanical, electrical and signaling circuitry needed to connect storage system 120 to the network. Illustratively, the computer network may be embodied as an Ethernet network or a FC network.

The storage adapter 240 cooperates with the storage operating system 230 executing on the system 224 to access information requested by SCS 132. The information may be stored on any type of attached array of writable storage device media such as video tape, optical, DVD, magnetic tape, bubble memory, electronic random access memory, flash memory devices, micro-electro mechanical and any other similar media adapted to store information, including data and parity information.

The storage adapter 240 comprises a plurality of ports having input/output (I/O) interface circuitry that couples to the disks over an I/O interconnect arrangement, such as a conventional high-performance, FC link topology.

In another aspect, instead of using a separate network and storage adapter, a converged adapter is used to process both network and storage traffic.

Storage Operating System:

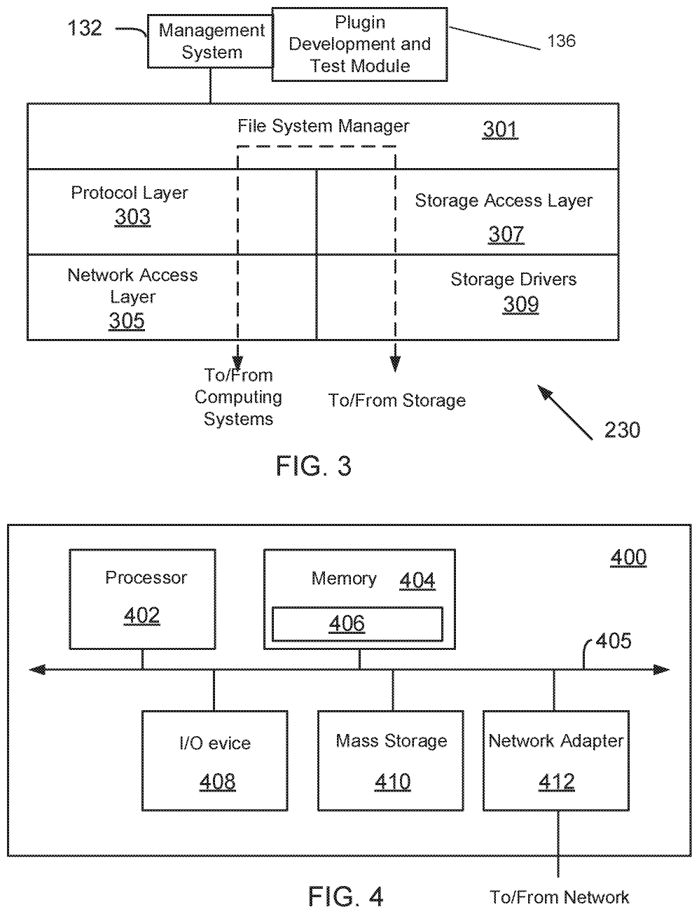

FIG. 3 illustrates a generic example of storage operating system 230 (or 124) executed by storage system 120 and interfacing with the management system 132, according to one aspect of the present disclosure. The storage operating system 230 maintains various stored objects and data containers for servers 102. The plugins that are developed using module 136 are used to assist in backing up, restoring, cloning and other storage services.

As an example, operating system 230 may include several modules, or “layers”. These layers include a file system manager 303 that keeps track of a directory structure (hierarchy) of the data stored in storage devices and manages read/write operations, i.e. executes read/write operations on disks in response to server system 102 requests.

Operating system 230 may also include a protocol layer 303 and an associated network access layer 305, to allow system 200 to communicate over a network with other systems, such as server system 102 and management system 132. Protocol layer 303 may implement one or more of various higher-level network protocols, such as NFS, CIFS, Hypertext Transfer Protocol (HTTP), TCP/IP and others, as described below.

Network access layer 305 may include one or more drivers, which implement one or more lower-level protocols to communicate over the network, such as Ethernet. Interactions between server systems 102 and mass storage devices 114/212 are illustrated schematically as a path, which illustrates the flow of data through operating system 230.

The operating system 230 may also include a storage access layer 307 and an associated storage driver layer 309 to communicate with a storage device. The storage access layer 307 may implement a higher-level disk storage protocol, such as RAID (redundant array of inexpensive disks), while the storage driver layer 309 may implement a lower-level storage device access protocol, such as FC or SCSI.

It should be noted that the software “path” through the operating system layers described above needed to perform data storage access for a client request may alternatively be implemented in hardware. That is, in an alternate aspect of the disclosure, the storage access request data path may be implemented as logic circuitry embodied within a field programmable gate array (FPGA) or an ASIC. This type of hardware implementation increases the performance of the file service provided by storage system 120.

As used herein, the term “storage operating system” generally refers to the computer-executable code operable on a computer to perform a storage function that manages data access and may implement data access semantics of a general purpose operating system. The storage operating system can also be implemented as a microkernel, an application program operating over a general-purpose operating system, such as UNIX® or Windows®, or as a general-purpose operating system with configurable functionality, which is configured for storage applications as described herein.

In addition, it will be understood to those skilled in the art that the invention described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a disk assembly directly-attached to a client or host computer. The term “storage system” should therefore be taken broadly to include such arrangements in addition to any subsystems configured to perform a storage function and associated with other equipment or systems.

Processing System:

FIG. 4 is a high-level block diagram showing an example of the architecture of a processing system, at a high level, in which executable instructions as described above can be implemented. The processing system 400 can represent management system 132 with module 136, host 102, and others. Note that certain standard and well-known components which are not germane to the present invention are not shown in FIG. 4.

The processing system 400 includes one or more processors 402 and memory 404, coupled to a bus system 405. The bus system 405 shown in FIG. 4 is an abstraction that represents any one or more separate physical buses and/or point-to-point connections, connected by appropriate bridges, adapters and/or controllers. The bus system 405, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 402 are the central processing units (CPUs) of the processing system 400 and, thus, control its overall operation. In certain aspects, the processors 402 accomplish this by executing programmable instructions stored in memory 404. A processor 402 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 404 represents any form of random access memory (RAM), read-only memory (ROM), flash memory, or the like, or a combination of such devices. Memory 404 includes the main memory of the processing system 400. Instructions 406 which implements techniques introduced above may reside in and may be executed (by processors 402) from memory 404. For example, instructions 406 may include code used for executing the process blocks of FIGS. 1D-1F, and the various components of module 136 described above with respect to FIG. 1C.

Also connected to the processors 402 through the bus system 405 are one or more internal mass storage devices 410, and a network adapter 412. Internal mass storage devices 410 may be or may include any conventional medium for storing large volumes of data in a non-volatile manner, such as one or more magnetic or optical based disks. The network adapter 412 provides the processing system 400 with the ability to communicate with remote devices (e.g., storage servers) over a network and may be, for example, an Ethernet adapter, a FC adapter, or the like. The processing system 400 also includes one or more input/output (I/O) devices 408 coupled to the bus system 405. The I/O devices 408 may include, for example, a display device, a keyboard, a mouse, etc.

Cloud Computing:

The system and techniques described above are applicable and especially useful in the cloud computing environment where storage is presented and shared across different platforms. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to a network, for example, the Internet and cloud computing allows shared resources, for example, software and information to be available, on-demand, like a public utility.

Typical cloud computing providers deliver common business applications online which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud.

After the application layer, is a cloud platform and cloud infrastructure, followed by a “server” layer that includes hardware and computer software designed for cloud specific services. The storage systems described above can be a part of the server layer for providing storage services. Details regarding these layers are not germane to the inventive aspects.

Thus, a method and apparatus for developing plugins have been described. Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the present disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A method, comprising:
generating by a processor, an application programming interface (API) template in a user preferred programming language to develop a plugin for a target system, the plugin customized for an application executed at the target system for providing a storage service associated with a storage object stored for the application;
validating by the processor, an operation that the plugin has to perform for the storage service;
uploading the plugin by the processor for deployment at the target system; and
testing the deployed plugin by the processor at the target system; wherein plugin generation, validation, deployment and testing is executed using an integrated management system that provides the storage service.

2. The method of claim 1, wherein the processor performs a syntax error check prior to the validation.

3. The method of claim 1, wherein a version of the plugin is checked prior to deployment.

4. The method of claim 1, wherein during testing an agent at the target system identifies the plugin, before a test operation is executed for the plugin.

5. The method of claim 1, wherein a same interface is used to generate, deploy and test the plugin.

6. The method of claim 1, wherein during testing, related operations are grouped for execution.

7. The method of claim 1, wherein code for the plugin is modified when a test operation fails.

8. A non-transitory, machine readable storage medium having stored thereon instructions for performing a method, comprising machine executable code which when executed by at least one machine, causes the machine to:
generate an application programming interface (API) template in a user preferred programming language to develop a plugin for a target system, the plugin customized for an application executed at the target system for providing a storage service associated with a storage object stored for the application;
validate an operation that the plugin has to perform for the storage service;
upload the plugin for deployment at the target system; and
test the deployed plugin at the target system; wherein plugin generation, validation, deployment and testing is executed using an integrated management system that provides the storage service.

9. The storage medium of claim 8, wherein a syntax error check is performed prior to the validation.

10. The storage medium of claim 1, wherein a version of the plugin is checked prior to deployment.

11. The storage medium of claim 8, wherein during testing an agent at the target system identifies the plugin, before a test operation is executed for the plugin.

12. The storage medium of claim 8, wherein a same interface is used to generate, deploy and test the plugin.

13. The storage medium of claim 8, wherein during testing, related operations are grouped for execution.

14. The storage medium of claim 8, wherein code for the plugin is modified when a test operation fails.

15. A system, comprising:
a memory containing machine readable medium comprising machine executable code having stored thereon instructions; and a processor coupled to the memory, the processor configured to execute the machine executable code to:
generate an application programming interface (API) template in a user preferred programming language to develop a plugin for a target system, the plugin customized for an application executed at the target system for providing a storage service associated with a storage object stored for the application;
validate an operation that the plugin has to perform for the storage service;
upload the plugin for deployment at the target system; and
test the deployed plugin at the target system; wherein plugin generation, validation, deployment and testing is executed using an integrated management system that provides the storage service.

16. The system of claim 15, wherein a syntax error check is performed prior to the validation.

17. The system of claim 15, wherein a version of the plugin is checked prior to deployment.

18. The system of claim 15, wherein during testing an agent at the target system identifies the plugin, before a test operation is executed for the plugin.

19. The system of claim 25, wherein a same interface is used to generate, deploy and test the plugin.

20. The system of claim 15, wherein during testing, related operations are grouped for execution.
